(19) United States
(12) Patent Application Publication
(10) Pub. No.: US 2007/0075822 A1
(43) Pub. Date: Apr. 5, 2007

(54) FUSE WITH CAVITY FORMING ENCLOSURE

(75) Inventors: Timothy E. Pachla, Berwyn, IL (US); Gordon T. Dietsch, Park Ridge, IL (US)

Correspondence Address: BELL, BOYD & LLOYD LLP, P.O. BOX 1135, CHICAGO, IL, 60690, US

(73) Assignee: LITTLEFUSE, INC., Des Plaines, IL (US)

(21) Appl. No.: 11/537,906

(22) Filed: Oct. 2, 2006

Related U.S. Application Data
(60) Provisional application No. 60/723,253, filed on Oct. 3, 2005.

(51) Int. Cl. H01H 85/04

(52) U.S. Cl. 337/297

(57) ABSTRACT

A surface mount fuse includes a substrate, a fuse element applied to the substrate, first and second terminals applied to substrate, first and second conductors connecting the fuse element electrically with the first and second terminals, and an enclosure coupled to the substrate, the enclosure covering the first and second conductors and defining a cavity overlying at least a portion of the fuse element, the cavity allowing for distortion of the fuse element upon its opening.

### PRIORITY CLAIM

This application claims priority to and the benefit of U.S. Provisional Patent Application “Fuse With Cavity Forming Enclosure,” Ser. No. 60/723,253, filed Oct. 3, 2005.

### BACKGROUND OF THE INVENTION

The present disclosure relates generally to circuit protection and more specifically to fuse protection.

Printed circuit boards (“PCB's”) have found increasing application in electrical and electronic equipment of all kinds. The components placed on the PCB control the electronic device. With cellular phones and other handheld electronic devices being designed and manufactured smaller and smaller, the need to save space on the PCB is critical.

The electrical circuits formed on the PCB's, like larger scale electrical circuits, need protection against electrical overloads. In particular, circuit boards and other electrical circuits within the telecommunications industry need protection against electrical overload. This protection can be provided by subminiature fuses that are physically secured to the PCB.

One problem common to most fuses is the potential mechanical distortion of the fuse element upon the opening of the element. Fuses can protect against two types of overcurrent situations, one in which a peak or instantaneous current surpasses a rated peak current of the fuse and another in which an amount of energy due to an overload condition or i2R energy surpasses a total energy rating or “let-through” energy rating. Fuse openings caused by instantaneous current surges in particular can lead to fairly severe mechanical distortion of the fuse element.

For numerous reasons, conductive portions of the fuse need to be insulated electrically. Mechanical distortion of the fuse element can cause the insulation to rupture or fly away from the opened fuse. In a closely spaced PCB environment, such ruptures or projectiles can cause damage to other components of the electronic devices.

Certain fuses, such as automotive blade fuses or cartridge fuses, provide insulating housings that are sized and configured to provide air gaps or arc barriers, which absorb the energy of an opened fuse or mechanically distorted fuse element. Such air gaps and arc barriers have not been possible to date with surface mount fuses, which have applied insulating coatings directly to the substrate and fuse element.

Accordingly, a need exists to provide a surface mount fuse having arc-quenching capabilities, and which is able to withstand mechanical distortion and disruption of the fuse element upon an opening thereof.

### SUMMARY OF THE INVENTION

Described herein are surface mountable fuses that allow for mechanical disruption and distortion of the fuse element upon the openings of the fuse. The fuses can also provide separate arc-quenching features. In one embodiment the fuse includes a substrate, a fuse element applied to the substrate, first and second terminals applied to substrate, first and second conductors connecting the fuse element electrically with the first and second terminals, and an enclosure coupled to the substrate. The enclosure is configured to cover the first and second conductors. It also defines a cavity overlying at least a portion of the fuse element, the cavity allowing for distortion of the fuse element upon its opening.

The substrate can be made of any suitable material, such as FR-4, epoxy resin, ceramic, resin coated foil, polytetrafluoroethylene, polyimide, glass and any combination thereof. Any of the fuse elements, first and second terminals, and first and second conductors can be made of at least one material, such as, copper, tin, nickel, silver, gold, alloys thereof and any combination thereof. The terminals, for example, can be plated with multiple conductive layers, such as additional copper layers, nickel layers, silver layers, gold layers, tin layers, and/or lead-tin layers. The fuse element and conductors for example may be formed as a single copper trace, in which the element is thinned or narrowed with respect to the conductors. At least one of the fuse element, first and second terminals, and first and second conductors can be applied to the substrate via a process, such as, etching, metalizing, laminating, adhering and any combination thereof.

The enclosure can be made of any suitable insulating material. In one preferred embodiment, the material is at least substantially rigid, so that it holds its shape and maintains the advantageous cavity. Suitable materials for the enclosure include hard silicon, polycarbonate, FR-4, or melamine.

In one embodiment, the enclosure includes a lid portion and a sidewall portion extending from the lid portion. The lid portion has an at least substantially uniform thickness, which is desirable because enough insulation can be applied over the entire area of the lid without having areas of extra, wasted thickness. In one implementation, the extending sidewall portion is coupled to the substrate, e.g., mechanically, chemically, thermally or via any combination thereof.

In one embodiment, a dissimilar metal, such as tin or tin-lead solder is applied to the fuse element at a location desirable for opening. The tin or tin-lead solder has a lower melting temperature than the copper element, so that upon an overcurrent or overload condition, the lower melting temperature metal melts first, adding heat to the element and quickening its response time. The fuse element in turn opens at that desirable location.

The enclosure can be sized to have the same footprint (length and width) as the base substrate or have a different footprint than the substrate. If the same, the terminals can be plated onto the edges of both the substrate and enclosure after they have been assembled. If different, the terminals can be plated onto the edges of the substrate before the enclosure and substrate have been assembled. In another embodiment, the terminals are (i) plated onto the substrate and the enclosure or (ii) plated onto the substrate only.

The cavity defined by the enclosure can be at least partially filled with a mechanically compliant, arc-quenching material, such as rubbery silicone. The compliant silicone absorbs the energy of a fuse opening. Its compliant nature also enables the element to move without disrupting the enclosure. The compliant silicone or other flexible material can be applied directly to the element in such a manner that a space or gap exists between the silicone and the bottom of the enclosure. Alternatively, the compliant silicone may completely fill the gap.

The rigid, cavity providing housing may also be employed with, e.g., cover, surface mount fuses having multiple fuse elements secured to an insulating substrate. U.S. patent application Ser. No. 11/046,367, titled: “Dual Fuse Link Thin Film Fuse,” filed Jan. 28, 2005, and assigned to the eventual assignee of this application, the entire contents of which are incorporated expressly herein by reference, discloses such multiple element fuses.

Here, a single fuse of can protect multiple conductive pathways of a same circuit or multiple different circuits. The fuse elements of the fuse can be rated the same or differently. The multiple elements can be placed in a non-symmetrical relationship with one another, so that it is difficult if not impossible to mount the fuses improperly. Further, certain portions of the insulating substrate can be metallized in addition to the terminal and fuse element metallizations to help balance the fuse during soldering. In that way, potential unequal surface tension forces during soldering due to an unbalanced metallization pattern are balanced. Such additional metallizations can render the multi-element fuses at least somewhat auto-alignable. The terminals are also structured so that diagnostic testing of the fuse can be performed without flipping the fuse, e.g., after the fuse is soldered to a PCB.

Various multi-element embodiments include fuse links having an X-shaped relationship to one another, a parallel relationship, a perpendicular relationship or a cross-shaped relationship, for example. In one embodiment, each fuse link extends to a unique pair of terminals. In another embodiment, the fuse links share one terminal, namely, a ground or common terminal.

The multi-element fuses can have upper and lower cavity forming enclosures. The cavity forming enclosures each cover an element and at least portions of the conductors or traces extending from or to the element. The terminals in one embodiment are built-up with multiple conductive layers so as to be at least substantially flush with the upper and lower enclosures. Or, the substrate can be milled or formed so that the terminal or outside edges of the substrate are raised with respect to the inner, fuse element portion of the substrate.

In one embodiment, a surface mount fuse includes a substrate, a fuse element applied to the substrate and first and second terminals applied to substrate. The surface mount fuse further includes first and second conductors connecting the fuse element electrically with the first and second terminals and an enclosure coupled to the substrate, the enclosure covering the first and second conductors and defining a cavity overlying at least a portion of the fuse element, the cavity allowing for distortion of the fuse element upon its opening.

In yet another embodiment, a surface mount fuse includes a substrate, a fuse element applied to the substrate, first and second terminals applied to substrate and first and second conductors connecting the fuse element electrically with the first and second terminals. The surface mount fuse further includes an enclosure coupled to the substrate, the enclosure having a different footprint that the substrate and defining a cavity overlying at least a portion of the fuse element, the cavity allowing for mechanical distortion of the fuse element upon its opening.

In still another embodiment, a surface mount fuse includes a substrate, a fuse element applied to the substrate, first and second terminals applied to substrate, first and second conductors connecting the fuse element electrically with the first and second terminals. The surface mount fuse further includes an enclosure coupled to the substrate, the enclosure defining a cavity overlying at least a portion of the fuse element, the cavity (i) allowing for mechanical distortion of the fuse element upon its opening and (ii) at least partially filled with an arc-quenching, mechanically complaint material.

It is therefore an advantage of the examples disclosed herein to provide an improved surface mountable fuse.

Another advantage of the examples disclosed herein is to provide a surface mount fuse with a cavity providing enclosure that mitigates the effects of the mechanical disruption or distortion of a fuse element upon an opening of same.

A further advantage of the examples disclosed herein is to provide such surface mount fuse and enclosure, wherein the cavity is further loaded with a mechanically compliant arc-quenching material.

Still another advantage of the examples disclosed herein is to provide such surface mount fuse and enclosure with a single fuse having multiple fuse links.

Additional features and advantages of the present invention are described in, and will be apparent from, the following Detailed Description of the Invention and the figures.

### BRIEF DESCRIPTION OF THE FIGURES

FIG. 1 is a sectioned front elevation view of one embodiment of a surface mount fuse having a cavity forming enclosure, wherein the enclosure has a different footprint than the base substrate of the fuse.

FIG. 2 is a sectioned front elevation view of another embodiment of a surface mount fuse having a cavity forming enclosure, wherein the enclosure has the same footprint as the base substrate of the fuse, and wherein the cavity is partially filled with a mechanically compliant, arc-quenching material.

FIG. 3 is a sectioned front elevation view of a further embodiment of a surface mount fuse having a cavity forming enclosure, wherein the enclosure has the same footprint as the base substrate of the fuse, and wherein the cavity is filled completely with a mechanically compliant, arc-quenching material.

FIGS. 4A to 4C are top, front and bottom views, respectively, of one embodiment of a fuse having a cavity forming enclosure, and which includes multiple fuse elements having a serpentine arrangement.

FIGS. 5A to 5C are top, front and bottom views, respectively, of another embodiment of a fuse having a cavity forming enclosure, and which includes multiple fuse elements having an asymmetrical, parallel relationship.

FIGS. 6A to 6C are top, front and bottom views, respectively, of a further embodiment of a fuse having a cavity forming enclosure, and which includes multiple fuse elements having an asymmetrical, X-shaped relationship.

FIGS. 7A to 7C are top, front and bottom views, respectively, of yet another embodiment of a fuse having a cavity forming enclosure, and which includes multiple fuse elements having an asymmetrical, cross-shaped configuration.

FIGS. 8A to 8C are top, front and bottom views, respectively, of a still further embodiment of a fuse having a cavity forming enclosure, and which includes multiple fuse elements having multiple load terminals fusibly connected to a single or ground or common terminal.

FIGS. 9A to 9C are top, front and bottom views, respectively, of yet a further embodiment of a fuse having a cavity forming enclosure and multiple fusible elements of the same or different current rating located on a single side of the fuse.

### DETAILED DESCRIPTION OF THE INVENTION

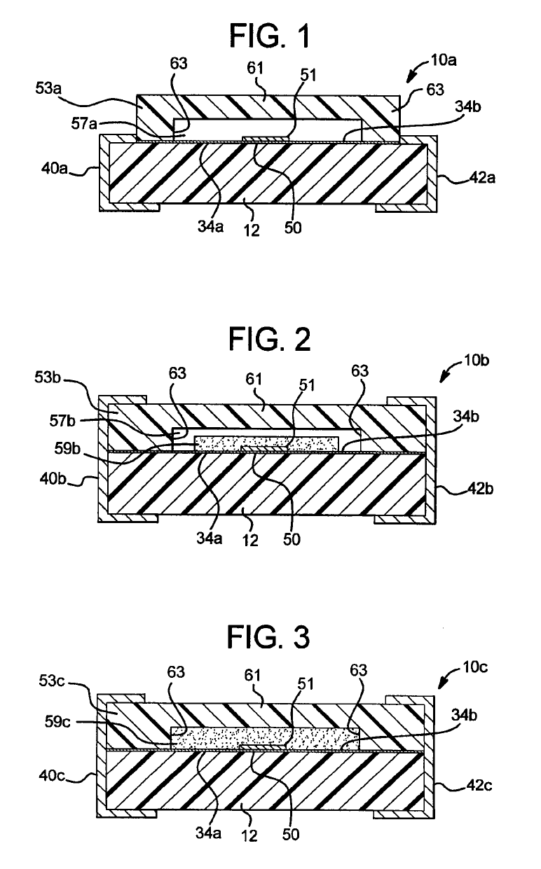

Referring now to the drawings, and in particular to FIG. 1 one embodiment of a fuse having a cavity forming enclosure is shown by surface mount fuse 10a. Fuse 10a includes an insulating substrate 12. Substrate 12 can be made of any suitable insulating material. In a preferred embodiment, the insulating material is both electrically and thermally insulating. Suitable materials for substrate 12 include FR-4, epoxy resin, ceramic, resin coated foil, polytetrafluoroethylene, polyimide, glass and any suitable combination thereof.

Applied to substrate are conductors 34a and 34b and fuse element 50, which in one embodiment are or include copper traces. Conductors and element 50 can be formed from a single copper trace, which is narrowed and/or thinned at one portion to form the element. The copper traces are etched onto substrate 12 via any suitable etching or metalizing process. One suitable process for etching the metal onto substrate 12 is described in U.S. Pat. No. 5,943,764 (“the '764 Patent”), assigned to the eventual assignee of the present application, the entire contents of which are incorporated herein by reference. Another possible way to metalize substrate 12 of fuse 10a is to adhere conductors 34a and 34b and element 50 to substrate 12. One suitable method for adhering the conductors 34a and 34b of fuse 10a to substrate 12 is described in U.S. Pat. No. 5,977,860, assigned to the eventual assignee of the present application, the entire contents of which are incorporated herein by reference. Alternatively, conductors 34a and 34b and element 50 are copper, tin, nickel, silver, gold, alloys thereof and any combination thereof.

As discussed, conductors 34a and 34b are narrowed and/or thinned as they extend towards each other. The narrowed/thinner portion of conductors 34a and 34b is the most likely the place for the pathways to open upon an overcurrent or overload condition. This portion is therefore termed the fuse element 50.

In the illustrated embodiment, a dissimilar metal deposition 51 is placed on fuse element 50. Deposition 51 in an embodiment includes pure tin, nickel or a combination of tin and lead, e.g., solder. Deposition 51 has a lower melting temperature than does the copper traces of the conductors 34a, 34b and fuse element 50. To that end, deposition 51 can be any metal or alloy having a lower melting temperature than the conductors 34a, 34b and fuse element 50. The addition of deposition 51 helps to ensure that the corresponding fuse element 50 opens at the narrowed location. When the deposition 51 heats-up due to an overcurrent condition, the alloy melts and causes an increased point of heat transfer on fuse element 50, which in turn melts before other points along the conductors 34a and 34b. In this way, the point at which fuse 10a opens is controllable and repeatable.

Conductors 34a and 34b communicate electrically with terminals 40a and 42a. As discussed in the '764 Patent, it may be desirable to place multiple conductive layers on one or more of the terminals 40a and 42a. The conductive layers of terminals 40a and 42a can include any number and combination of layers of copper, nickel, silver, gold, tin, lead-tin and other suitable metals. The terminals can have the same or different numbers and types of conductive layers.

An at least semi-rigid, cavity forming enclosure 53a is fixed to substrate 12. Enclosure 53a includes a lid portion 61 and a sidewall portion 63 extending downwardly from lid portion 61. Lid portion 61 has an at least substantially uniform thickness, which is desirable because it ensures that a proper level of insulation is provided without providing an unnecessary amount of insulation in any area. Enclosure 53a is made of any suitably rigid, insulating material, such as silicone, polycarbonate, FR-4 or melamine.

Lid portion 61 and sidewall portion 63 form a cavity 57a. The sidewalls portion 63 extend away from the lid portion 61 to create a gap or cavity of the same height.

Cavity 57a provides room for element 50 to move or deform upon an opening of element 50, without in turn deforming or dislodging enclosure 53a. Sidewall portion 63 is fastened to substrate 12 via any suitable method, such as mechanically, adhesively and/or thermally or in any other suitable manner. Enclosure 53a covers all of element 50, deposition 51 and conductors 34a and 34b in the illustrated embodiment. Terminals 40a and 40b remain exposed. Enclosure 53a of device 10a has a smaller footprint (length and width) than does substrate 12. Accordingly, terminals 40a and 40b are formed on substrate 12, e.g., before enclosure 53a is attached to substrate 12.

Fuse 10a can be rated for any suitable surface mount peak current and let-through energy rating.

In FIG. 2, an at least semi-rigid cavity forming enclosure 53b is fixed to substrate 12. Enclosure 53b includes a lid portion 61 and a sidewall portion 63 extending downwardly from lid portion 61. Lid portion 61 has an at least substantially uniform thickness, which is desirable as described above. Enclosure 53b is made of any suitably material listed above. All of the materials and methods for making enclosure 53a of FIG. 1 are applicable to enclosure 53b of FIG. 2. Except, as discussed below, enclosure 53b has the same footprint as substrate 12.

Lid portion 61 and sidewall portion 63 form a cavity 57b. Cavity 57b provides room for element 50 to move or deform upon an opening of element 50, without in turn deforming or dislodging enclosure 53b. Further, a mechanically compliant, arc-quenching material 59b, such as silicone is applied to fuse element 50, deposition 51, a portion of terminals 34a and 34b and a portion of substrate 12. An air gap still exists, however, between material 59b and the inner surface of lid portion 61 of enclosure 53b.

Arc-quenching material 59b absorbs energy from the opening of fuse element 50. Its rubbery or compliant nature however enables element 50 to deform without deforming or rupturing enclosure 53b. The open space 57b around arc-quenching material 59b also enables the material and the element to move upon an opening of element 50.

Sidewall portion 63 is fastened to substrate 12 via any suitable method, such as mechanically, adhesively and/or thermally. Enclosure 53b covers all of fuse element 50, deposition 51 and conductors 34a and 34b. Enclosure 53b of device 10b has the same footprint (length and width) as base 12. Accordingly, terminals 40a and 42b are formed on substrate 12 and enclosure 53b in one embodiment, e.g., after enclosure 53b is attached to substrate 12.

Fuse 10b can be rated for any suitable surface mount peak current and let-through energy rating.

In FIG. 3, an at least semi-rigid cavity forming enclosure 53c is fixed to substrate 12. Enclosure 53c includes a lid portion 61 and a sidewall portion 63 extending downwardly from lid portion 61. Lid portion 61 has an at least substantially uniform thickness, which is desirable as described above. Enclosure 53c is made of any suitably material listed above.

Lid portion 61 and sidewall portion 63 form a cavity, which in the illustrated embodiment is filled completely with arc-quenching material 59c. The cavity provides room for fuse element 50 to move or deform upon an opening of fuse element 50, without in turn deforming or dislodging enclosure 53c. Further, mechanically compliant, arc-quenching material 59c absorbs energy from the opening of fuse element 50. Its rubbery or compliant nature however enables fuse element 50 to deform without deforming or rupturing enclosure 53c.

Sidewall portion 63 is fastened to substrate 12 via any suitable method, such as mechanically, adhesively and/or thermally. Enclosure 53c covers all of element 50, deposition 51 and conductors 34a and 34b. Enclosure 53c of device 10c has the same footprint (length and width) as base 12. Accordingly, terminals 40a and 40b are formed on substrate 12 and enclosure 53c in one embodiment, e.g., after enclosure 53c is attached to substrate 12.

Fuse 10c can also be rated for any suitable surface mount peak current and let-through energy rating.

Any of fuses 10a to 10c can be provided in any desirable surface mount size, such as, for example an 0402, 0604, 0805 and/or 1206 packages. Conductors 40a, 42a, 40b, 42b, 40c, 42c may be arranged according to any applicable industry standards.

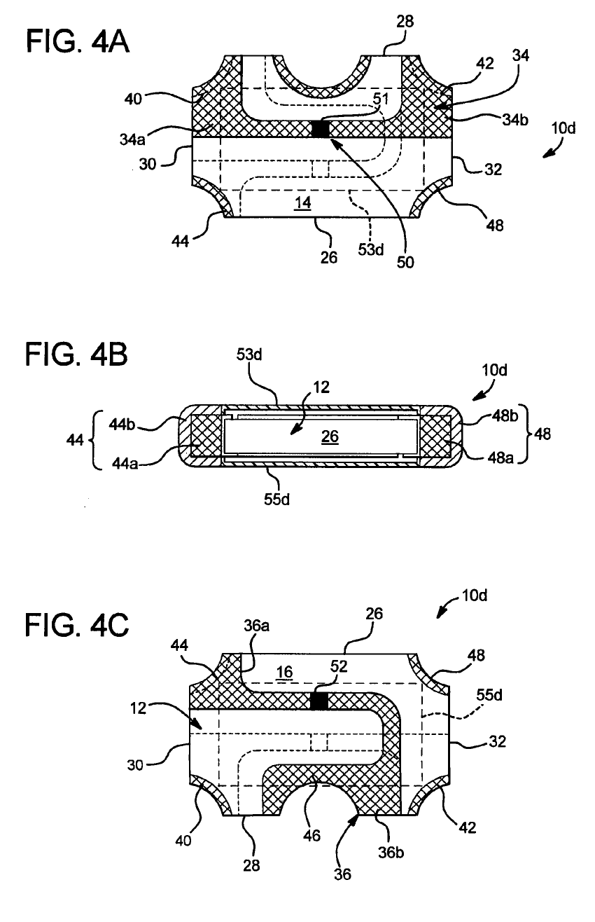

Referring now FIGS. 4A to 4C, one embodiment of a dual fuse link surface-mountable fuse having upper and lower cavity forming enclosures 53d and 55d, respectively, is illustrated by fuse 10d. Fuse 10d includes a substrate 12 that has a top 14 and a bottom 16. Substrate 12 also has a front 26, a back 28, a left side 30, and a right side 32. Fuse 10d includes separate conductive pathways or fuse links 34, 36 attached to the top and bottom surfaces 14, 16, respectively. Fuse link 34 includes separate conductive pathways 34a and 34b (referred to collectively as fuse link 34).

A metal deposition 51 is placed on the interface between conductive pathways 34a and 34b, which is approximately in the middle of fuse link 34. Likewise, fuse link 36 includes two separate pathways 36a and 36b (referred to collectively as fuse link 36). A metal deposition 52 is placed on the interface between pathways 36a and 36b, approximately in the middle of fuse link 36. First fuse link 34 and metal deposition 51 are located on top 14 of substrate 12. Second fuse link 36 and metal deposition 52 are located on the bottom 16 of substrate 12.

Fuse links 34 and 36 in one embodiment are or include copper traces. The copper traces are etched or adhered to substrate 12 via any suitable etching or metalizing process, such as those described above for fuse 10a. The metal depositions 51 and 52 in an embodiment include a combination of tin and lead, e.g., solder, as described above and operate the same as described above. Namely, the addition of metal depositions 51 and 52 helps to ensure that the corresponding fuse link opens at the narrowed location e.g., at tin-lead spots 50 and 52.

As illustrated, conductive pathway 34a extends to a terminal 40 located at one of the corners of substrate 12. As seen in FIG. 4A, conductive pathway 34b extends to a second terminal 42 located at a different corner of substrate 12. As seen in FIG. 4C, terminals 40 and 42 of fuse link 34 in one embodiment extend from the top 14, down sides 30 and 32 and cover a portion of the bottom 16 of substrate 12. Extending the terminals along multiple surfaces of the substrate enables each of the fuse links to be tested diagnostically from one side of the fuse or without having to flip the fuse, e.g., after it has been mounted to a parent printed circuit board (“PCB”).

FIG. 4C illustrates the terminals 44 and 46 of second serpentine shaped fuse link 36 having second metal deposition 52. As seen in FIG. 4C, conductive pathway 36a extends to terminal 44, which is located at a third corner of substrate 12. Conductive pathway 36b extends to terminal 46, which is located along the back 28 of substrate 12. As seen in FIGS. 4A and 4B, terminal 44 extends up side 30 and front 26 and along a portion of top 14 of substrate 12. Likewise, terminal 46 extends up back 28 and along a portion of top 14 of substrate 12.

As seen in FIGS. 4A to 4C, fuse links 34 and 36 do not extend to one of the four corners of substrate 12. Nevertheless, that fourth corner is metalized along a portion of the top 14, front 26, side 32 and bottom 16 of substrate 12. That is, a fourth terminal 48 is provided that does not connect electrically to either of the fuse links 34 and 36.

Separate terminal 48 is provided for multiple reasons. First, a metallization at the fourth corner of substrate 12 enables fuse 10d to be soldered properly to the parent PCB. Enabling all four corners of fuse 10d to be soldered (e.g., reflow soldered) to the parent PCB helps to ensure that fuse 10d is mounted flushly on the PCB and is not tilted or angled upward from one or more sides or corners of fuse 10d. Dummy terminal 48 balances surface tension forces when fuse 10d is soldered to the PCB, so that fuse 10d is aligned correctly in a X-Y or planar direction along the surface of the parent PCB. Terminal 48 also enables fuse 10d to be secured at all four corners to strengthen the connection between fuse 10d and the parent PCB. Terminal 48 may also help diagnostically.

A further reason to metalize the fourth corner with dummy terminal 48 is to streamline the manufacturing process. As discussed in the '764 Patent, one of the last steps in manufacturing fuse 10d is to dice or cut individual fuses from a large sheet of multiple fuses. A process very similar to that described in the '764 Patent can be used to produce fuse 10d. Accordingly, fuse 10d at a point in the manufacturing step is adjacent to up to eight other fuses (four lateral and four diagonal). The quarter circle at dummy terminal 48 is adjacent to quarter circles of three terminals of three other fuses. The four quarter circles of four fuses together form a bore or hole. It is easier to plate the entire hole than it is to not plate the dummy terminal 48 portion and plate instead only three-quarters of the hole for actual terminals of the other fuses. For multiple reasons, dummy terminal 48 is desirable.

As discussed above, it may be desirable to place multiple conductive layers on one or more of the terminals 40, 42, 44, 46 and 48. The conductive layers of terminals 40 to 46 can include any number and combination of layers of copper, nickel, silver, gold, tin, lead-tin and other suitable metals. The terminals can have the same or different numbers and types of conductive layers.

The configuration of the terminals in FIGS. 4A to 4C is advantageous for multiple reasons. First, fuse links 34 and 36 and associated metal depositions 51 and 52 are thermally decoupled from one another. For one reason, metal depositions 51 and 52 are placed on opposite sides of substrate 12 from one another. Also, metal depositions 51 and 52 are misaligned laterally or in a planar direction with respect to each other. That is, the elements are not placed directly above and below one another. Instead, the spacing or arrangement of elements 51 and 52 is offset as seen in top and bottom views, respectively, of FIGS. 4A and 4C. Spacing the elements 51 and 52 apart in three directions helps to insulate the elements from one another to prevent false triggering.

Another advantage of the fuse link configuration shown in FIGS. 4A to 4C is that fuse links and metal depositions may be sized or structured differently to produce a differently rated fuse link. For example, fuse link 34 (including separate pathways 34a and 34b) and metal deposition 51 located on the top 14 of substrate 12 may be rated differently, e.g., ten amps, than is bottom side fuse link 36 (including pathways 36a and 36b) and metal deposition 52, which could be rated for five amps or fifteen amps. Generally, either of the fusible links and associated metal depositions can be rated for any suitable amperage and let-through energy.

The non-symmetrical arrangement of the fuse links on the top 14 and bottom 16 of fuse 10d makes an improper mounting of fuse 10d more difficult. That is, the mounting footprint of terminals 40 and 42 of the fuse link 34 and metal deposition 51 is different than (e.g., will not mate or mount to mounting pads that mate with terminals 44 and 46) the mounting footprint of fuse link 36 and terminals 44 and 46 located on the bottom 16 of fuse 10d. The reverse is also true. That is, the mounting pads of a parent PCB that mate with terminals 44 and 46 of fuse link 36 will not mate with and cannot mount to terminals 40 and 42 of fuse link 34. The configuration of fuse links 34 and 36 on fuse 10d therefore prevents or tends to prevent an assembler from placing an improperly rated fuse in a circuit or improperly mounting fuse 10d.

As seen in FIG. 4B, fuse 10d includes cavity forming enclosures 53d and 55d. Enclosures 53d and 55d include lid and sidewall portions as described above. The sidewall portions are fixed to substrate 12 via any method described above. Enclosures 53d and 55d form gaps or cavities that enable the elements (located at depositions 51, 52) to deform upon opening without deforming or dislodging enclosures 53d and 55d. The cavities may be partially or fully filled with a mechanically compliant, arc-quenching material, such as silicone, as described above.

Enclosures 53d and 55d are also shown in phantom in FIGS. 4A and 4B. As seen, the enclosures 53d and 55d cover portions of links 34a and depositions 51 and 52. Enclosures 53d and 55d, like enclosures 53a to 53c, inhibit corrosion and oxidation of the fusible links 34 and 36 as well as metal depositions 51 and 52. The enclosures also protect those items from mechanical impact and aid in the distribution and manufacture of fuse 10d, for example, by providing a surface on which a tool can apply a vacuum to pick and place fuse 10d. The enclosures as discussed also help to control the melting, ionization and arching that occur when one of the fusible links opens upon an overload condition.

As illustrated in FIG. 4B, terminals 44 and 48 are built-up via multiple metal layers 44a/44b and 48a/48b, respectively, so that the outer layers of the terminals are at least substantially flush with the top and bottom of enclosures 53d and 55d, respectively. This enables fuse 10d to be properly surface mounted. Terminals 40 and 42 are likewise built-up.

In an alternative embodiment, top 14 and bottom 16 of substrate 12 are machined, milled, etched, formed initially or otherwise formed to have an inner depressed or recessed area, which is then covered by enclosure 53d and 55d. The enclosures 53d and 55d when added to fixed substrate 12 reside at least substantially flush with the outer terminal portions of substrate 12.

The teachings previously described with respect to fuse 10d of FIGS. 4A to 4C are applicable to the remaining fuses discussed herein. The remaining fuses differ primarily in the configuration and arrangement of the fuse links, metal depositions and associated terminals. Each of the materials discussed above for the substrate, fusible links, terminals and metal depositions is applicable to each of the remaining fuses. For ease of illustration, those materials, methods of fabrication or application are not repeated in all cases for each of the foregoing fuses.

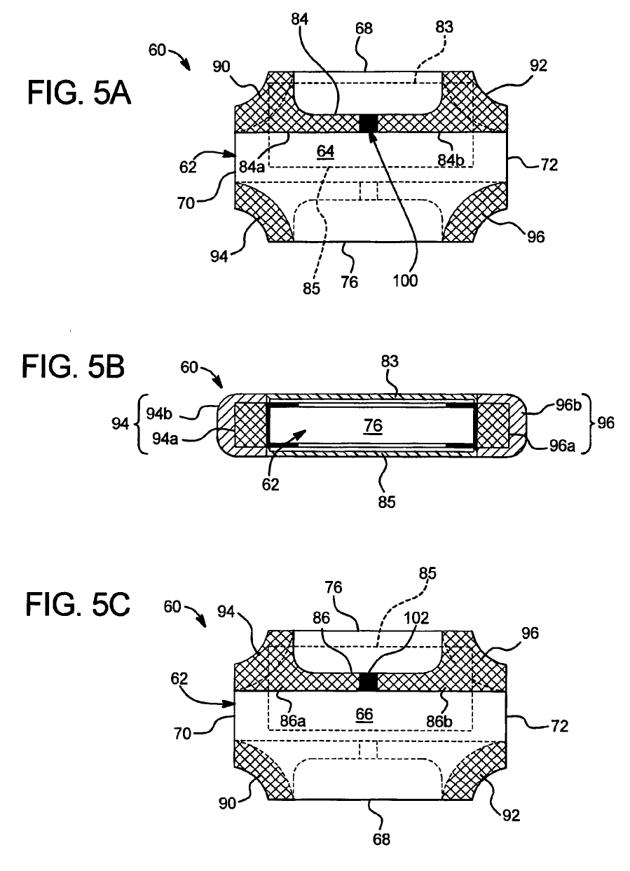

For purposes of illustration, each of the fuses is given a name that is descriptive of the shape or relative configuration of the fuse links and metal depositions on the respective fuses. Accordingly, fuse 10d described in FIGS. 4A to 4C is labeled a serpentine fuse because of the serpentine shape of fuse link 36. Fuse 60 discussed in FIGS. 5A to 5C is accordingly labeled an asymmetrical, parallel fuse.

In FIGS. 5A to 5C, symmetrical, parallel fuse 60 includes many of the same components described above for the serpentine fuse 10d of FIGS. 4A to 4C. In particular, fuse 60 includes an insulating substrate 62 having a top 64, bottom 66, back 68, sides 70 and 72 and a front 76. Fuse links 84 and 86 are plated, etched, adhered or otherwise secured to substrate 62. Fuse link 84 includes conductive pathways 84a and 84b that extend to terminals 90 and 92, respectively. Fuse link 86 includes conductive pathways 86a and 86b that extend to terminals 94 and 96, respectively. A metal deposition 100 is placed on fuse link 84 to help provide a definite point at which fuse link 84 opens upon an overcurrent condition. Likewise, a metal deposition 102 is placed on fuse link 86 to provide a definite point at which fuse link 86 will open.

Fuse links 84 and 86 are sized (thickness and width) to open at a set and desired overcurrent level. Fuse links 84 and 86 may be rated the same or differently from one another. Given the parallel and symmetrical arrangement of the fuse links and terminals of fuse 60, it may be desirable for the fuse links to have the same rating, so that the fuses are mounted properly no matter which surface 64 or 66 of substrate 12 is placed onto the parent PCB.

As seen in FIGS. 5A to 5C, terminals 90 to 96 each extend down/up respective sides 70 and 72, front 76 and rear 68 of substrate 62. The terminals further extend along a portion of the opposite top 64 or bottom 66, respectively. Unlike the fuse 10d of FIGS. 4A to 4C, all four corners of fuse 60 are consumed by terminals 90 to 96, which each extend from one of the fusible links 84 and 86. Accordingly, fuse 60 of FIGS. 5A to 5C does not need a dummy terminal.

In the parallel, symmetrical arrangement of fuse 60, or with any of the fuses described herein, it is expressly contemplated to provide two substrates 62 that sandwich an inner metallic layer having a third fusible link and element, third set of conductive pathways that extend to a third set of terminals. The third set of terminals (not illustrated) in one embodiment are metallized on the outside of the two substrates 62, for example at front 76 and back 68 or otherwise away from the corners where terminals 90 to 96 are located. In this way, more than two fuse links and metal depositions per assembly are possible. The present disclosure also includes the provision of any suitable number of insulating substrates and conductive layers located between the insulating layers. Each of the separate fusible links extends to a terminal located on at least one outer surface of the fuse. The three or more terminals may each be rated the same, some rated differently, each rated differently or any combination thereof.

As seen in FIG. 5B, fuse 60 includes cavity forming enclosures 83 and 85. Enclosures 83 and 85 include lid and sidewall portions as described above. The sidewall portions are fixed to substrate 62 via any method described above. Enclosures 83 and 85 form gaps or cavities that enable the elements (located at depositions 100, 102) to deform upon opening without deforming or dislodging enclosures 83 and 85. The cavities may be partially or fully filled with a mechanically compliant, arc-quenching material as, such as silicone, described above.

Enclosures 83 and 85 are also shown in phantom in FIGS. 5A and 5B. As seen, the enclosures cover portions of links 84 and 86 and depositions 100 and 102.

Enclosures 83 and 85 inhibit corrosion and oxidation of the fusible links and metal depositions 100 and 102. The enclosures also protect those items from mechanical impact and aid in the distribution and manufacture of fuse 60, for example, by providing a surface on which a tool can apply a vacuum to pick and place fuse 60. The enclosures as discussed also help to control the melting, ionization and arching that occur when one of the fusible links opens upon an overload condition.

As illustrated in FIG. 5B, terminals 94 and 96 are built-up via multiple metal layers 94a/94b and 96a/96b, respectively, so that the outer layers of the terminals are at least substantially flush with the top and bottom of enclosures 83 and 85, respectively. This enables fuse 60 to be properly surface mounted. Terminals 90 and 92 are likewise built-up. In an alternative embodiment, substrate 62 is machined or formed as described above in connection with FIG. 4B, so that enclosures 83 and 85 reside at least substantially flush with the outer terminal portion of substrate 62.

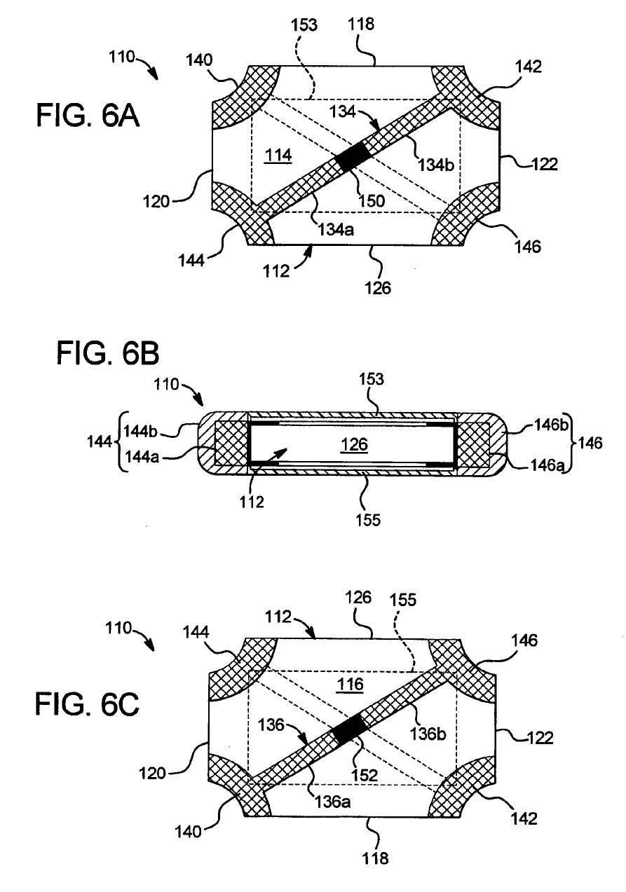

Refer now to FIGS. 6A to 6C, a third fuse 110 is illustrated. Fuse 110 includes many of the same components as fuses 10d and to 60 described above. Fuse 110 for apparent reasons is called an X-shaped, symmetrical fuse. X-shaped, symmetrical fuse 110 includes a substrate 112. Substrate 112 is made of any of the materials described above. Substrate 112 includes a top 114, a bottom 116, sides 120 and 122, a front 126 and aback 118.

A fuse link 134 including conductive pathways 134a and 134b is placed on the top 114 of fuse 110 via any of the methods described above. Likewise, fuse link 136 including conductive pathways 136a and 136b is placed on the bottom 116 of substrate 112 via any of the methods described herein. Fuse links 134 and 136 include metal depositions 150 and 152, respectively.

Conductive pathways 134a and 134b of fuse link 134 extend to terminals 144 and 142, respectively. Likewise, pathways 136a and 136b of fuse link 136 extend to terminals 140 and 146, respectively. Terminals 140 to 146 cover each of the corners of substrate 112. Accordingly no dummy terminal, like the one shown in FIGS. 4A to 4C, is provided. Terminals 140 to 146 extend down/up the front, back and sides of substrate 112 and cover a portion of the surface opposite of their respective fuse links, as has been described herein.

X-shaped, symmetrical fuse 110 is well suited to have an inner third or forth etc., metal layer, comprising additional fuse links and metal depositions. Also, due to the symmetrical nature of fuse 110, it may be desirable for fuse links 134 and 136 to have the same current ratings so that fuse 110 may be mounted in multiple directions, without fear of protecting a circuit with an improperly rated overcurrent protection device.

Links, terminals and elements 150 and 152 are made of any of the materials described above. Metal depositions 150 and 152 as shown are aligned with one another with respect to an axis extending out of the page. It may be desirable for thermal coupling reasons to alternatively offset the placement of the metal deposition.

As seen in FIG. 6B, fuse 110 includes cavity forming enclosures 153 and 155. Enclosures 153 and 155 include lid and sidewall portions as described above. The sidewall portions are fixed to substrate 112 via any method described above. Enclosures 153 and 155 form gaps or cavities that enable the elements (located at depositions 150, 152) to deform upon opening without deforming or dislodging enclosures 153 and 155. The cavities may be partially or fully filled with a mechanically compliant, arc-quenching material, such as silicone, as described above.

Enclosures 153 and 155 are also shown in phantom in FIGS. 6A and 6C. As seen, the enclosures cover portions of links 134 and 136 and depositions 150, 152.

Enclosures 153 and 155 inhibit corrosion and oxidation of the fusible links and metal depositions 150 and 152. The enclosures 153 and 155 also protect those items from mechanical impact and aid in the distribution and manufacture of fuse 110, for example, by providing a surface on which a tool can apply a vacuum to pick and place fuse 110. The enclosures as discussed also help to control the melting, ionization and arching that occur when one of the fusible links opens upon an overload condition.

As illustrated in FIG. 6B, terminals 144 and 146 are built-up via multiple metal layers 144a/144b and 146a/146b, respectively, so that the outer layers of the terminals are at least substantially flush with the top and bottom of enclosures 153 and 155, respectively. This enables fuse 110 to be properly surface mounted. Terminals 140 and 142 are likewise built-up. In an alternative embodiment, substrate 112 is machined or formed as described above.

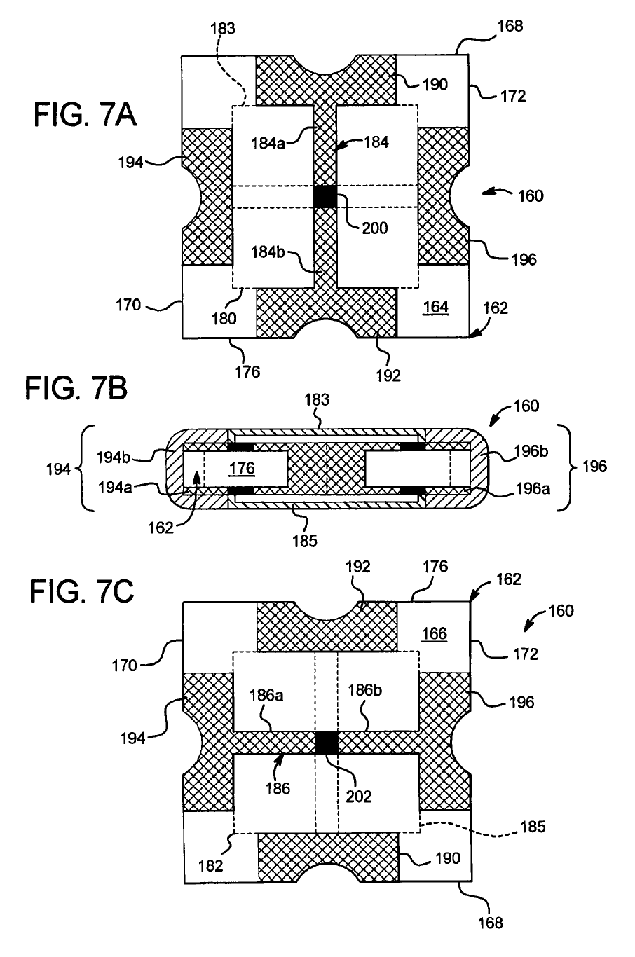

Referring now to FIGS. 7A to 7C, a further alternative fuse 160 is illustrated. Fuse 160 includes a substrate 162 and fuse links 184 and 186. Fuse link 184 is placed on the top 164 of substrate 162. Fuse link 186 is placed on the bottom 166 of substrate 162. Substrate 162 also includes sides 170 and 172, front 176 and rear 168.

Fuse 160 is different from the other fuses shown and described herein because the corners of substrate 162 are not metallized, rather the inner portions of sides 170 and 172, front 176 and rear 168 are metallized. The centers of those portions are shown having semi-circular cut-outs or bores. The bores are originally completely circular when a plurality of fuses 160 are made in a sheet, before the fuses 160 are separated or diced into the individual fuses 160. Nevertheless, because each front, back and side of fuse 160 includes a terminal or metallization, fuse 160 is solderable to a parent PCB without experiencing unbalanced surface tension forces and is or tends to be auto-alignable without additional dummy terminals.

Fuse 160 for apparent reasons is called a cross-shaped symmetrical fuse. Fuse links 184 and 186 may be rated the same or differently. In one embodiment because fuse 160 is symmetrical and fuse links 184 and 186 are rated for the same ampage so that the fuse may be soldered in multiple configurations without fear of improper mounting. Fuse links 184 and 186 include metal depositions 200 and 202, respectively, which may be of any the types described herein.

It should be appreciated from the foregoing examples that the fuses and substrates of the present disclosure can have many different shapes, fuse link configurations and terminal configurations. The fuses and substrates are also be sized to support a fuse having any suitable desired rating. The overall dimensions of the fuses can be an order of 1/16 inch (1.59 mm) and be generally square in shape or have rectangular dimensions. The thickness of the substrate or fuse can be on the order of a 1/64 inch (0.40 mm). In alternative embodiments, the dimensions of the fuse are bigger or smaller than the listed dimensions as desired and/or thicker than the thickness listed. The thickness of the traces in one embodiment is on the order of 0.005 inch (0.13 mm).

As seen in FIG. 7B, fuse 160 includes cavity forming enclosures 183 and 185. Enclosures 183 and 185 include lid and sidewall portions as described above. The sidewall portions are fixed to substrate 162 via any method described above. Enclosures 183 and 185 form gaps or cavities that enable the elements (located at depositions 200, 202) to deform upon opening without deforming or dislodging enclosures 183 and 185. The cavities may be partially or fully filled with a mechanically compliant, arc-quenching material, such as silicone, as described above.

Enclosures 183 and 185 are shown covering portions of links 184 and 186 and depositions 200, 202 in FIGS. 7A and 7B.

Enclosures 183 and 185 inhibit corrosion and oxidation of the fusible links and metal depositions 200 and 202. The enclosures 183 and 185 also protect those items from mechanical impact and aid in the distribution and manufacture of fuse 160, for example, by providing a surface on which a tool can apply a vacuum to pick and place fuse 160. The enclosures as discussed also help to control the melting, ionization and arching that occur when one of the fusible links opens upon an overload condition.

As illustrated in FIG. 7B, terminals 194 and 196 are built-up via multiple metal layers 194a/194b and 196a/196b, respectively, so that the outer layers of the terminals are at least substantially flush with the top and bottom of enclosures 183 and 185, respectively. This enables fuse 160 to be properly surface mounted. Terminals 190 and 192 are likewise built-up. Alternatively, substrate 162 can be machined or formed as discussed above.

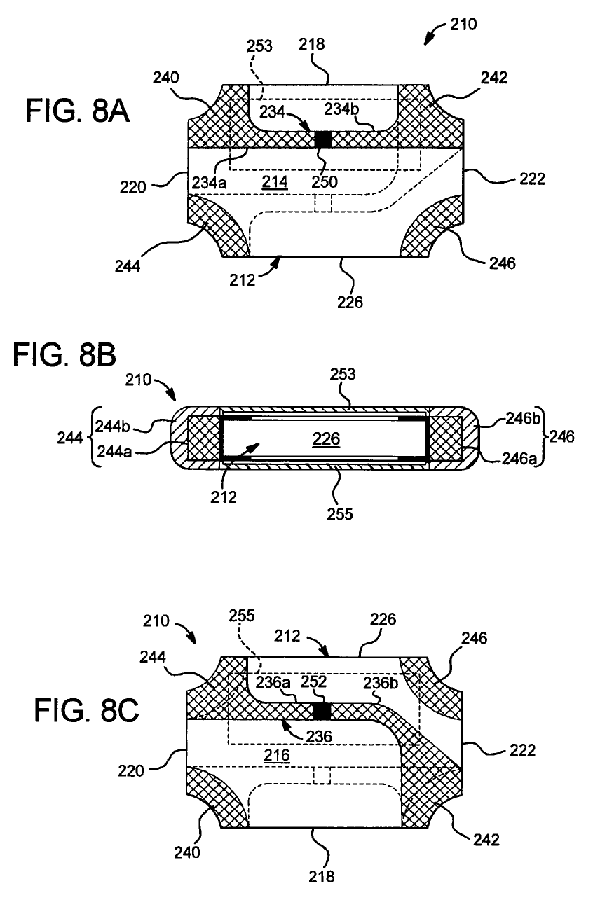

Referring now to FIGS. 8A to 8C, an alternative embodiment of the surface mount use of the present disclosure is illustrated by fuse 210. Fuse 210 as illustrated includes a single ground or common terminal 242 that connects electrically via separate fuse links 234 and 236 to load terminals 240 and 244.

Fuse 210 includes an insulating substrate 212. Insulating substrate 212 includes a top 214, a bottom 216, sides 220 and 222, a front 226 and a rear 218. A fuse link 234 is placed on the top 214 of substrate 212. Fuse link 234 includes a first conductive pathway 234a that extends to load terminal 240. Fuse link 234 includes a second conductive pathway 234b that extends to ground or common terminal 242.

Fuse link 236 is placed on the bottom 216 of substrate 212 of fuse 210. Fuse link 236 includes a first conductive pathway 236a that extends to load terminal 244. Fuse link 236 includes a second conductive pathway 236b that extends to ground or common terminal 242.

A metal deposition 250 is placed fuse link 234. A metal deposition 252 is disposed on fuse link 236. Fuse links 234 and 236 are secured to substrate 212 via any of the embodiments discussed above. Likewise, metal depositions 250 and 252 are made according to any of the embodiments discussed herein. Metal depositions 250 and 252 as well as fuse links 234 and 236 can be rated the same or differently. The fuse links are separated from one another in three dimensions for thermal decoupling. The non-symmetrical relationship between fuse links 234 and 236 also makes fuse 210 well suited for different current ratings because the fuse 210 is difficult to mount improperly.

As seen in FIGS. 8A and 8C, three of the four corners of substrate 212 are metallized via terminals 240, 242 and 244. For reasons discussed above, dummy terminal 246 is provided in one preferred embodiment. As further illustrated, each of the terminals extends around portions of three different sides of substrate 212. Terminals 240 to 246 can each be plated with multiple conductive layers, such as multiple copper layers, nickel, silver, gold or lead-tin layers as can the terminals of any of the fuses discussed herein.

Fuse 210 protects multiple load lines that lead to a single ground or common terminal. It should be appreciated that it is also possible to provide two substrates 212 sandwiching an internal metal layer, which enables three or more load terminals to be fusibly connected to a single ground or common terminal 242. Fuse 210 protects multiple load devices having a common negation or ground line.

As seen in FIG. 8B, fuse 210 includes cavity forming enclosures 253 and 255. Enclosures 253 and 255 include lid and sidewall portions as described above. The sidewall portions are fixed to substrate 212 via any method described above. Enclosures 253 and 255 form gaps or cavities that enable the elements (located at depositions 250, 252) to deform upon opening without deforming or dislodging enclosures 253 and 255. The cavities may be partially or fully filled with a mechanically compliant, arc-quenching material as described above.

Enclosures 253 and 255 are shown covering portions of links 234 and 236 and deposition 250, 252 in FIGS. 8A and 8C.

Enclosures 253 and 255 inhibit corrosion and oxidation of the fusible links and metal depositions 250 and 252. The enclosures also protect those items from mechanical impact and aid in the distribution and manufacture of fuse 210, for example, by providing a surface on which a tool can apply a vacuum to pick and place fuse 210. The enclosures also help to control the melting, ionization and arching that occur when one of the fusible links opens upon an overload condition.

As illustrated in FIG. 8B, terminals 244 and 246 are built-up via multiple metal layers 244a/244b and 246a/246b, respectively, so that the outer layers of the terminals are at least substantially flush with the top and bottom of enclosures 253 and 255, respectively. This enables fuse 210 to be properly surface mounted. Terminals 240 and 242 are likewise built-up. Alternatively, substrate 212 can be machined as discussed above.

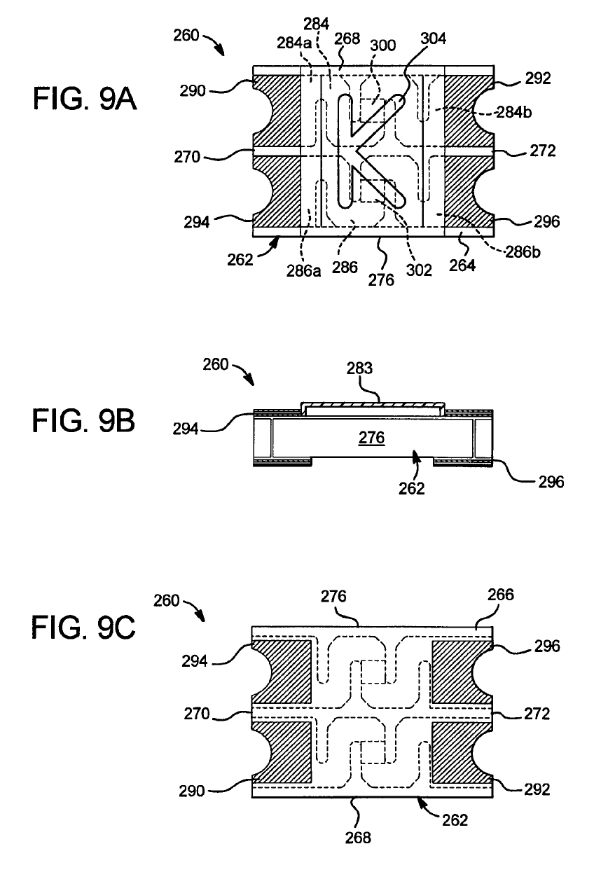

Referring now to FIGS. 9A and 9C, a further alternative embodiment of the present disclosure is illustrated by fuse 260. In each of the previous embodiments, the fuse links and metal depositions were thermally insulated from one another by being placed on opposite sides of the insulating substrate. Also described herein, the fuse links and metal depositions can be separated by multiple substrates, for example, when three or more fuse links are provided and in an X-Y or planar direction. Fuse 260 on the other hand illustrates an alternative embodiment where multiple fuse links 284 and 286 each having a metal deposition 300 and 302, respectively, are placed on a same surface 264 of substrate 262 of fuse 260. It is possible that a planar separation between fuse links 184 and 186 can be made large enough to provide both links on the same surface of the substrate. It is therefore contemplated to place multiple fuse links on multiple surfaces, for example, to provide four total fuse links in one device.

Fuse 260 includes a substrate 262 as mentioned. Substrate 262 includes a top 264, a bottom 266, sides 270 and 272, a front 276 and a rear 268. As discussed, fuse links 284 and 286 are placed on the same top surface 264 of fuse 260. Fuse links 284 and 286 and their respective metal depositions 300 and 302 are rated the same or differently as desired. The fuse links and metal depositions are applied via any of the methods discussed above and include any of the different materials disclosed herein.

Fuse link 284 includes a conductive pathway 284a that extends to terminal 290. A conductive pathway 284b of fuse link 284 extends to terminal 292. Likewise, conductive pathway 286a of fuse link 286 extends to terminal 294, while conductive pathway 286b of fuse link 286 extends to terminal 296. Terminals 290 to 296 each extend along three sides of substrate 262 as seen in FIGS. 9A and 9C. FIG. 9B further illustrates that the terminals can be plated with multiple conductive layers as discussed above.

Because fuse 260 is relatively symmetrical, the surface tension forces created during soldering should be balanced, making the mounting of fuse 260 to a parent PCB a process that is at least somewhat auto-aligning. The fuse is alternatively configured non-symmetrically, for example, when providing fuse links with different current ratings.

As seen in FIG. 9B, fuse 260 includes cavity forming enclosure 283. Enclosure 283 includes lid and sidewall portions as described above. The sidewall portions are fixed to substrate 262 via any method described above. Enclosure 283 forms gaps or cavities that enable the elements to deform upon opening without deforming or dislodging enclosure 283. The cavities may be partially or fully filled with a mechanically compliant, arc-quenching material as described above.

Enclosure 283 inhibits corrosion and oxidation of the fusible links and metal depositions. The enclosures also protect those items from mechanical impact and aid in the distribution and manufacture of fuse 260, for example, by providing a surface on which a tool can apply a vacuum to pick and place fuse 260. The enclosures as discussed also help to control the melting, ionization and arching that occur when one of the fusible links opens upon an overload condition.

As illustrated in FIG. 9B, terminals 294 and 296 are built-up via multiple metal layers, respectively, so that the outer layers of the terminals are at least substantially flush with the top and bottom of enclosures 283 and 285, respectively. This enables fuse 260 to be properly surface mounted. Terminals 290 and 292 are likewise built-up.

At least one of the tops of enclosures 283 and 285 includes marking or branding indicia 304, which includes any suitable information, such as fuse rating information, manufacturer information and the like. Any of the embodiments discussed herein can have indicia 304.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A surface mount fuse comprising:
a substrate;
a fuse element applied to the substrate;
first and second terminals applied to substrate;
first and second conductors connecting the fuse element electrically with the first and second terminals; and
an enclosure coupled to the substrate, the enclosure covering the first and second conductors and defining a cavity overlying at least a portion of the fuse element, the cavity allowing for distortion of the fuse element upon its opening.

2. The surface mount fuse of claim 1, wherein the substrate is made of a material selected from the groups consisting of: FR-4, epoxy resin, ceramic, resin coated foil, polytetrafluoroethylene, polyimide, glass and any combination thereof.

3. The surface mount fuse of claim 1, wherein at least one of the fuse elements, first and second terminals, and first and second conductors is made of at least one material selected from the group consisting of: copper, tin, nickel, silver, gold, alloys thereof and any combination thereof.

4. The surface mount fuse of claim 1, wherein at least one of the fuse element, first and second terminals, and first and second conductors is applied to the substrate via a process selected from the group consisting of: etching, metalizing, laminating, adhering and any combination thereof.

5. The surface mount fuse of claim 1, wherein the enclosure includes a lid portion having an at least substantially uniform thickness.

6. The surface mount fuse of claim 1, wherein the enclosure includes a sidewall portion extending from the lid portion, the sidewall portion coupled to the substrate.

7. The surface mount fuse of claim 1, wherein the enclosure is coupled to the substrate mechanically, chemically, thermally or via any combination thereof.

8. The surface mount fuse of claim 1, wherein the surface mount fuse includes a deposition of a dissimilar metal on the fuse element at a location desirable for opening.

9. The surface mount fuse of claim 1, wherein the first and second terminals are (i) plated onto the substrate and the enclosure or (ii) plated onto the substrate only.

10. The surface mount fuse of claim 1, wherein the enclosure has at least one characteristic selected from the group consisting of: (i) being at least substantially rigid; (ii) having a footprint at least substantially the same as the substrate; and (iii) being sized to cover multiple fuse elements.

11. The surface mount fuse of claim 1, wherein the cavity is at least partially filled with an arc-quenching material.

12. A surface mount fuse comprising:
a substrate;
a fuse element applied to the substrate;
first and second terminals applied to substrate and first and second conductors connecting the fuse element electrically with the first and second terminals; and
an enclosure coupled to the substrate, the enclosure having a different footprint that the substrate and defining a cavity overlying at least a portion of the fuse element, the cavity allowing for mechanical distortion of the fuse element upon its opening.

13. The surface mount fuse of claim 12, wherein the cavity is at least partially filled with an arc-quenching material.

14. The surface mount fuse of claim 12, wherein the enclosure covers the first and second conductors.

15. The surface mount fuse of claim 12, wherein the first and second conductors are plated onto the substrate only.

16. A surface mount fuse comprising:
a substrate;
a fuse element applied to the substrate;
first and second terminals applied to substrate;
first and second conductors connecting the fuse element electrically with the first and second terminals;
an enclosure coupled to the substrate, the enclosure defining a cavity overlying at least a portion of the fuse element, the cavity (i) allowing for mechanical distortion of the fuse element upon its opening and (ii) at least partially filled with an arc-quenching, mechanically complaint material.

17. The surface mount fuse of claim 16, wherein the enclosure covers the first and second conductors.

18. The surface mount fuse of claim 16, wherein the first and second terminals are (i) plated onto the substrate and the enclosure or (ii) plated onto the substrate only.

19. The surface mount fuse of claim 16, wherein the enclosure has at least one characteristic selected from the group consisting of: (i) being at least substantially rigid; (ii) having a footprint at least substantially the same as the substrate; and (iii) being sized to cover multiple fuse elements.

20. The surface mount fuse of claim 16, wherein the enclosure includes a lid portion having an at least substantially uniform thickness.
